(19) United States
(12) Patent Application Publication
(10) Pub. No.: US 2005/0250636 A1
(43) Pub. Date: Nov. 10, 2005

(54) Device, assembly and method for producing bags as well as such a bag

(76) Inventor: Petrus Josef Franciscus Slenders, Ec Maarheeze (NL)

Correspondence Address: Richard P. Berg, ESQ.;c/o LADAS & PARRY, Suite 2100, 5670 Wilshire Boulevard, Los Angeles, CA, 90036-5679, US

(21) Appl. No.: 11/110,641

(22) Filed: Apr. 19, 2005

(30) Foreign Application Priority Data
Apr. 20, 2004 (NL) 1025987

(51) Int. Cl. B31B 49/02

(52) U.S. Cl. 493/143

(57) ABSTRACT

A device and a method for producing bags. The device is provided with at least one assembly comprising a first and a second jaw. The jaws are movable in directions towards and away from each other. The tubular foil, which can be moved in a direction of transport, is to be provided with a seam extending transversely to the direction of transport between said first and said second jaw so as to form a bag, The first jaw is provided with a projection, which projection can be moved away from and towards a recess in the second jaw, transversely to the direction of transport. In said recess, a portion of the tubular foil can be formed into an edge provided with a seam can be formed on the bag.

The invention relates to a device for producing bags, which device is provided with at least one assembly comprising a first and a second jaw, which jaws are movable in directions towards and away from each other, wherein a tubular foil, which can be moved in a direction of transport, is to be provided with a seam extending transversely to the direction of transport between said first and said second jaw so as to form a bag, said first jaw being provided with a projection that is movable transversely to the direction of transport.

The invention further relates to such an assembly.

The invention also relates to a method for producing bags from a tubular foil, which foil is led between at least a first and a second jaw in a direction of transport, after which a seam extending transversely to the direction of transport is formed on the foil by means of the jaws, which can be moved together, so as to form a bag, whereupon said jaws are moved apart, said first jaw being provided with a projection.

The invention also relates to such a bag produced by using the method according to the invention.

With such a device and method for producing bags, as known from NL-8,006,200, the second jaw comprises a fixed jaw as well as welding jaw that is pivotable about a pivot pin. A projection on the first jaw is movable transversely to the direction of transport for moving the foil towards the second jaw, to a position between the fixed jaw and the pivotable jaw. After the foil has been positioned between the fixed jaw and the pivotable jaw, the projection is moved away from the second jaw. Following that, a seam can be formed on the foil by heat supplying means in the pivotable jaw by pivoting the pivotable jaw towards the fixed jaw, thus obtaining a folded edge provided with a seam.

A drawback of this known device and method is that two separate steps are needed for forming a folded edge provided with the seam.

The object of the present invention is to provide a device by means of which a bag provided with at least one seam can be produced in a simple and efficient manner, whilst the edge of the bag is given a shape other than an upright shape.

This object is accomplished with the device according to the invention in that the projection can be moved away from and towards a recess in the second jaw, whilst heat supplying means are present in one end of the projection and/or in the recess, by means of which a seam is to be formed on a portion of the tubular foil between the recess and a projection, whilst at the same time a folded edge provided with the seam can be formed on the bag.

Using the device according to the invention, a seam as well as a folded edge are obtained at the same time. A desired pressure can be exerted on the foil between the projection and a wall of the recess by the projection so as to form a relatively strong seam. Within the context of the present document, the term folded edge is understood to mean an end of the tubular foil that is folded about a fold line that extends parallel to the seam. Using the device according to the invention, it is therefore possible in a simple manner to obtain a folded edge provided with a seam, with the fold line being located near or on the seam. The folded edge provided with the seam on the bag can be formed in a single operation, which enhances the efficiency of the device.

It is noted that from U.S. Pat. No. 4,350,003 there is likewise known a device for producing bags. In said device, a first seam is formed on a tubular foil by moving a first and a second jaw together. Substantially simultaneously therewith, the foil is cut through with a knife so as to form a bag, and the foil that is present between the knife and the seam can be moved into a recess by means of a projection. In said projection, a temporary seam can be formed on a foil by means of a hot gas. The seam is relatively weak, because it is formed by the mere application of heat. To form a relatively strong seam it is necessary to apply pressure to the foil for a certain length of time in addition to heat.

It is furthermore noted that European patent application EP-A1-0 276 628 discloses a method and a device in which a tubular foil is led between the jaws in a direction of transport, after which the jaws are moved together to be pressed against the tubular foil, with a seam being formed in the tubular foil through the application of heat and pressure. The foil is cut through, thereby forming an upright edge on the tubular foil, which edge forms one end of the bag. A drawback of the above-described prior art is the fact that the bag that is eventually formed by means of said device comprises an upright edge.

Another embodiment of the device according to the invention is characterized in that the shape of the recess is complementary to the round shape of the end of the projection.

Since the round shape of both the end of the projection and the recess does not comprise any acute transitions, the risk of the foil being damaged is practically excluded.

Another embodiment of the device according to the invention is characterized in that the assembly comprises a third and a fourth jaw, which jaws are movable in directions towards and away from each other, between which jaws the tubular foil, which is movable in the direction of transport, is to be provided with a further seam extending transversely to the direction of transport.

Said further seam may be a lower seam of a bag to be formed, whilst the seam in the folded edge may be an upper seam of said bag, or vice versa. A sealed bag is obtained by forming a lower seam and an upper seam.

Yet another embodiment of the device according to the invention is characterized in that the first and the second jaw form a first pair of jaws and the third and the fourth jaw form a second pair of jaws, with the assembly comprising a cutting device disposed between said first pair of jaws and said second pair of jaws for cutting through the tubular foil.

In this way a portion of the tubular foil provided with a seam, which is to form the bag, can be cut loose from the tubular foil by means of the cutting device in a simple manner.

Another embodiment of the device according to the invention is characterized in that the device comprises a clamping device disposed before the cutting device, seen in the direction of transport.

The clamping device clamps down the tubular foil, thus providing support for the foil that has been cut through by the cutting device, which can subsequently be provided with the folded edge, for example.

Yet another embodiment of the device according to the invention is characterized in that the device is provided with a foil feed-through space located between the cutting device and the first and the second jaw.

After the tubular foil has been cut through, the portion of the foil that extends before the cutting device, seen in the direction of transport, is present in the foil feed-through space. Said portion of the bag is at least partially pressed into the recess by the projection for forming the folded edge provided with the seam. Said portion is thereby moved away from the cutting device.

Yet another embodiment of the device according to the invention is characterized in that the assembly comprises pressure means that are movable parallel to the direction of transport in the recess for pressing down the folded edge. In this way foil portions located on either side of a fold line are pressed together, which gives the bag a smooth appearance.

The invention furthermore provides an assembly having the features of the assembly that is mounted in the device.

The advantage of said assembly is that it can be mounted in conventional devices for producing bags to replace the jaws that are used therein.

Another object of the invention is to provide a method for obtaining a bag having at least one seam from a tubular foil in a simple and efficient manner, wherein the edge of the bag is given a shape other than an upright shape.

This object is accomplished with the method according to the invention in that the tubular foil is moved into a recess in the second jaw transversely to the direction of transport by means of the projection, wherein a seam is formed in the foil through the application of heat, whilst at the same time a folded edge is formed on the foil between the projection and the recess.

By forming a seam on the tubular foil in this simple manner, a folded edge is simultaneously formed in the recess of the second jaw by the projection on the first jaw.

An advantageous embodiment of the method according to the invention is characterized in that the assembly is provided with pressure means that are movable parallel to the direction of transport in the recess for pressing down the folded edge.

A smooth appearance of the edge is obtained by pressing down the two portions of the folded edge present on either side of a fold line.

Another advantageous embodiment of the method according to the invention is characterized in that another seam is formed on the tubular foil by means of a third and a fourth jaw prior to the forming of said seam and said folded edge, whereupon the tubular foil that is clamped down by means of a clamping device is cut through by means of a cutting device, after which a portion of the foil that has been cut loose, which is needed for forming the folded edge provided with the seam, is positioned in a foil feed-through space and subsequently pressed into the recess.

In this way a folded edge provided with a seam is formed on a bag in a simple and efficient manner.

Another object of the invention is to provide a bag having an edge provided with a seam, which edge has a shape other than an upright shape.

This object is accomplished with the bag according to the invention in that the edge is folded about a fold line, with the seam being located near the fold line.

The folded edge, which is formed simultaneously with the seam, makes the bag according to the invention look different.

One embodiment of the bag according to the invention is characterized in that the folded edge abuts against a wall of the bag, wherein, after the walls of the bag located on either side of the seam have been moved apart and the seam has been broken, the edge tends to return to the position in which it abuts against the wall.

An edge formed in this manner makes it possible to reseal the bag after the seam has been opened. The edge tends to return to the position in which it abuts against the wall and the contents of the bag are sealed off near the fold line.

Another embodiment of the bag according to the invention is characterized in that the edge can be held in the position in which it abuts against the wall by means of a resealable adhesive strip.

In this way the bag is prevented from being opened undesirably and the bag can be opened and closed several times.

The invention will now be explained in more detail with reference to the drawing, in which:

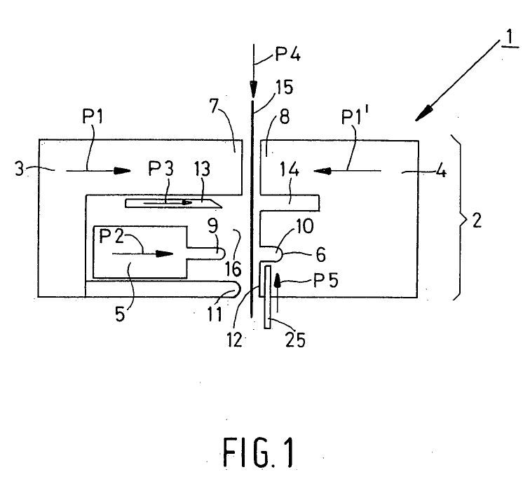

FIGS. 1-7 are cross-sectional views of the device according to the invention during various phases of the method according to the invention;

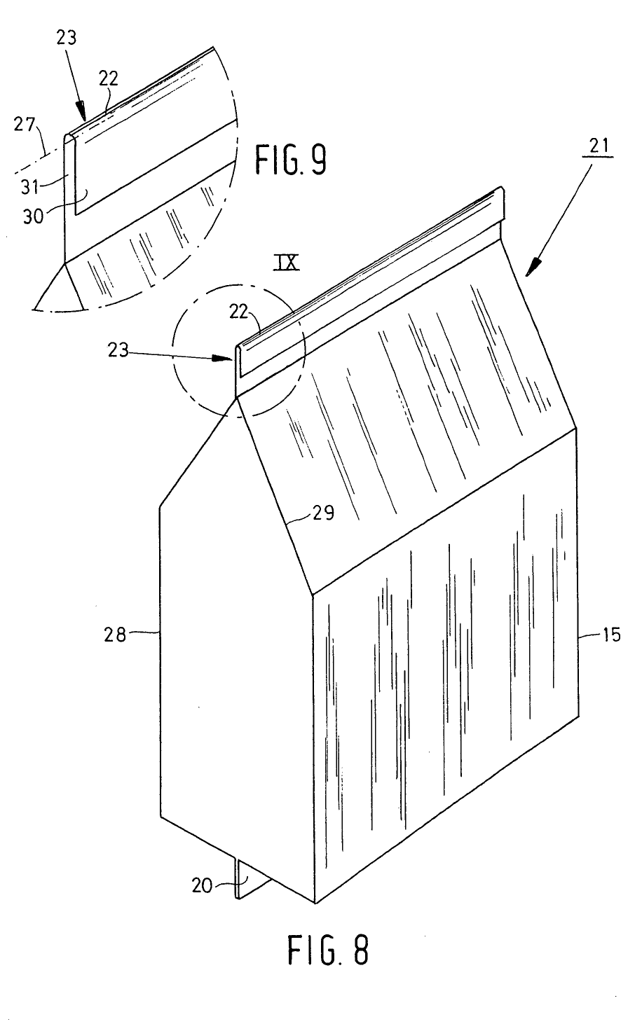

FIG. 8 is a perspective view of an embodiment of a bag according to the invention;

FIG. 9 is a larger-Scale perspective view of a folded edge of the bag of FIG. 8.

Like parts are indicated by the same numerals in the figures.

The device 1 that is shown in FIGS. 1-7 is provided with an assembly 2. The assembly 2 comprises two parts 3, 4, which are movable relative to each other in the direction indicated by the arrow P1 and in the opposite direction. The first part 3 is provided with a first jaw 5, which cooperates with a second jaw 6 present on the second part 4, which jaws 5, 6 form a first pair of jaws. The first part 3 further comprises a third jaw 7, which cooperates with a fourth jaw 8 present on the second part 4, which jaws 7, 8 form a second pair of jaws.

The second and the fourth jaw 6, 8 present on the second part 4 are rigidly interconnected.

The first jaw 5 is provided with a projection 9, which can be moved together with the jaw 5 in the direction indicated by the arrow P2 and in the opposite direction with respect to the first part 3, towards the second jaw 6, which is provided with a recess 10, into which the projection 9 can be moved.

The assembly 2 further comprises a clamping device, which comprises a projection 11 on the first part 3 and a bearing surface 12 on the second part 4. The assembly 2 is furthermore provided with a cutting device, which comprises a knife 13 on the first part 3 and a groove 14 in the second part 4. The knife 13 can be moved in the direction indicated by the arrow P3 and in the opposite direction with respect to the first part 3, into and out of the groove 14.

The device 1 is furthermore provided with a foil transport mechanism (not shown), which guides a tubular foil 15 between the parts 3, 4 in a direction indicated by the arrow P4.

Seen in the direction of transport P4, the first pair of jaws 5, 6 is disposed before the second pair of jaws 7, 8. Disposed between the first pair of jaws 5, 6 and the second pair of jaws 7, 8 is the cutting device. The clamping device is disposed before the first pair of jaws 5, 6, seen in the direction of transport P4. Disposed between the cutting device and the first pair of jaws 5, 6 is a foil feed-through space 16.

The operation of the device 1 and of the method according to the invention will now be explained with reference to FIGS. 1-7.

In the device 1, the tubular foil 15 is transported between the moved-apart parts 3, 4 in the direction indicated by the arrow P4 (FIG. 1).

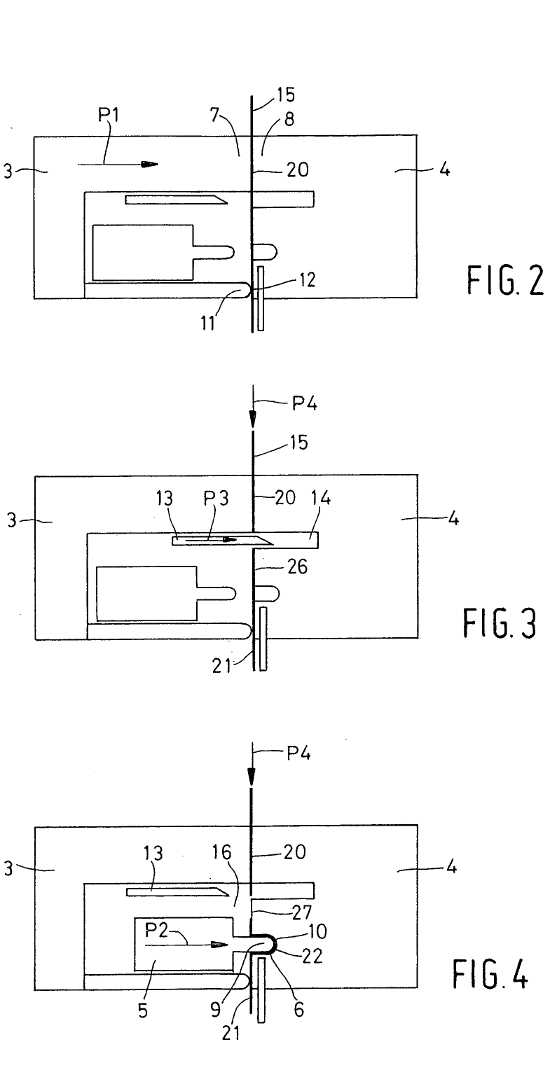

Then the first part 3 and the second part 4 are moved together in the direction indicated by arrow P1, P1′, until the third jaw 7 and the fourth jaw 8 are pressed against the tubular foil 15. The foil is locally heated by heat supplying means mounted in the jaws 7, 8, forming a seam 20 transversely to the direction of transport P4 in the tubular foil 15. At the same time, the tubular foil 15 is clamped down between the projection 11 and the bearing surface 12 of the clamping device (FIG. 2).

After the seam 20 has been formed on the tubular foil 15 through the application of heat and pressure, the knife 13 is moved in the direction indicated by the arrow P3, into the groove 14, cutting through the tubular foil 15 before the seam 20, seen in the direction of transport P4 (FIG. 3).

Then the knife 13 is returned to the starting position that is shown in FIG. 1 (FIG. 4). The portion of the tubular foil 15 that lies before the cutting device, seen in the direction of transport P4, will form a bag 21. The bag 21 is clamped down by the clamping device, with a portion 26 of the bag 21 to be formed being present in the foil feed-through space 16.

In a preceding operation, the tubular foil 15 of the bag 21 has been provided with a seam 20 in the same manner as described above, which seam is located a predetermined distance before the first and the second jaw 6, 7.

The projection 9 on the first jaw 5 is now moved in the direction indicated by the arrow P2 towards the recess 10 in the second jaw 6, and with the portion 26 of the foil of the bag 21 that is present in the foil feed-through space 16 being pressed into the recess 10 by the projection 9 and being moved in the direction indicated by the arrow P4. No foil is present now at the position 27 of the part 4.

A folded edge 23 provided with a seam 22 is now formed in the foil that is present in the recess 10 by means of heat supplying means present in the projection 9 and in the recess 10 (FIG. 4).

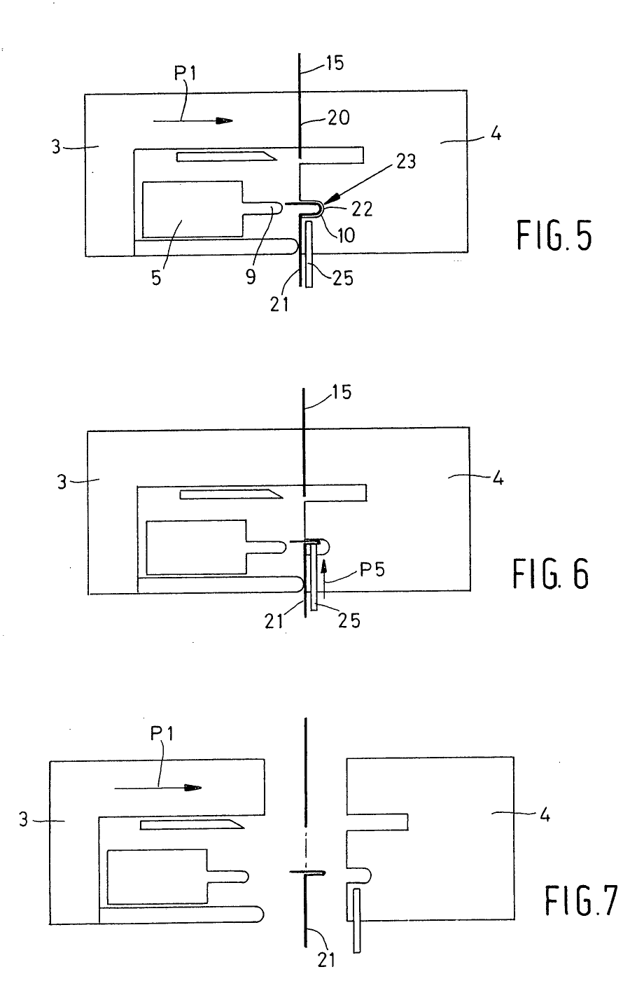

After the seam 22 has been formed, the projection 10 is moved in the opposite direction of the arrow P2 to the starting position that is shown in FIG. 1 (FIG. 5).

Pressure means 25 are positioned opposite the recess 10, which pressure means are movable in the direction indicated by the arrow P5 and in the opposite direction, from a position outside the recess 10 to a position inside the recess 10. The pressure means 25 press down the edge 23 provided with the seam 22 (FIG. 6).

Following that, the parts 3, 4 are moved apart to the position that is shown in FIG. 1 (FIG. 7). The bag 21 provided with seams 20, 22 and with the folded edge is now released (FIG. 7).

The device 1 as described above is furthermore provided with a roller (not shown), along which the bag 21 is led after the folded edge 23 has been formed. The roller folds the folded edge 23 from the position that is shown in FIG. 7 to a position as shown in FIG. 8.

FIG. 8 shows a bag 21 according to the invention, which bag 21 is provided with tubular foil 9 as well as with a lower seam 20 and a folded edge 23 formed in accordance with the invention. The bag 21 is furthermore provided with fold lines 28, 29, which have been formed in the foil 15, using means that are known per se, upon forming the bag 21. The edge 23 that has been folded about a fold line 27 is provided with a seam 22. The folded edge 23 is shown on a larger scale in FIG. 9.

The folded edge 23 of the bag 21 may additionally be provided with an adhesive strip (not shown), by which the folded portion 30 of the edge 23 can be affixed to the other apart 31 of the edge 23.

The seam 22 can be opened in a correct manner by folding up the folded portion 30 of the edge 23. Subsequently, the seam 22 is opened by pulling the walls of the tubular foil apart. The bag 21 can be resealed by placing the portion 30 back in the folded position that is shown in FIGS. 8 and 9. A fold located near the opened seam 22 seals the bag 21 in that case. Said folding of the portion 30 will partially be effected by the material properties of the heat-formed edge 23.

The device 1 as described above is a packaging machine, for example, in which a product to be packaged is introduced into the bag 21 to be formed after the first seam 20, also referred to as the bottom seam, has been formed. After the product has been supplied to the bag to be formed, the foil is moved in the direction of transport P4 and the bag to be formed is provided with an edge 23 provided with a seam 22, also referred to as the upper seam, in the manner as described above.

The projection 9 and the recess 10 have a round shape, seen in cross-sectional view, to ensure an adequate conduction of the heat generated by the heat supplying means. It is also possible, however, to use a different shape for the recess and the projection. In addition, it is possible to provide the projection 9 and/or the recess 10 with two heat supplying means, in which case two seams will be formed in the folded edge.

Alternatively, the device 1 may not be fitted with a clamping device and a foil feed-through space. When such a device is used, the edge 23 provided with the seam 22 is formed first, and the foil to be pressed into the recess is supplied from a bottom side by lifting the bag 21 to be formed, as it were. The foil is only cut through by the knife 13 after the edge 23 has been formed. A drawback of such an embodiment, however, is the fact that the weight of the foil to be lifted partially depends on the product present in the foil, so that said weight will not be constant when product changes occur.

1. A device for producing bags, which device is provided with at least one assembly comprising a first and a second jaw, which jaws are movable in directions towards and away from each other, wherein a tubular foil, which can be moved in a direction of transport, is to be provided with a seam extending transversely to the direction of transport between said first and said second jaw so as to form a bag, said first jaw being provided with a projection that is movable transversely to the direction of transport, characterized in that the projection can be moved away from and towards a recess in the second jaw, whilst heat supplying means are present in one end of the projection and/or in the recess, by means of which a seam is to be formed on a portion of the tubular foil between the recess and a projection, whilst at the same time a folded edge provided with the seam can be formed on the bag.

2. A device according to claim 1, characterized in that the shape of the recess is complementary to the round shape of the end of the projection.

3. A device according to claim 1, characterized in that the assembly comprises a third and a fourth jaw, which jaws are movable in directions towards and away from each other, between which jaws the tubular foil, which is movable in the direction of transport, is to be provided with a further seam extending transversely to the direction of transport.

4. A device according to claim 3, characterized in that the first and the second jaw form a first pair of jaws and the third and the fourth jaw form a second pair of jaws, with the assembly comprising a cutting device disposed between said first pair of jaws and said second pair of jaws for cutting through the tubular foil.

5. A device according to claim 4, characterized in that the device comprises a clamping device disposed before the cutting device, seen in the direction of transport.

6. A device according to claim 4, characterized in that the device is provided with a foil feed-through space located between the cutting device and the first and the second jaw.

7. A device according to claim 1, characterized in that the assembly comprises pressure means that are movable parallel to the direction of transport in the recess for pressing down the folded edge.

8. An assembly suitable for use in a device according to claim 1.

9. A method for producing bags from a tubular foil, which foil is led between at least a first and a second jaw in a direction of transport, after which a seam extending transversely to the direction of transport is formed on the foil by means of the jaws, which can be moved together, so as to form a bag, whereupon said jaws are moved apart, said first jaw being provided with a projection, characterized in that the tubular foil is moved into a recess in the second jaw transversely to the direction of transport by means of the projection, wherein a seam is formed in the foil through the application of heat, whilst at the same time a folded edge is formed on the foil between the projection and the recess.

10. A method according to claim 9, characterized in that pressure means are moved parallel to the direction of transport in the recess for pressing down the folded edge.

11. A method according to claim 9, characterized in that another seam is formed on the tubular foil by means of a third and a fourth jaw prior to the forming of said seam and said folded edge, whereupon the tubular foil that is clamped down by means of a clamping device is cut through by means of a cutting device, after which a portion of the foil that has been cut loose, which is needed for forming the folded edge provided with the seam, is positioned in a foil feed-through space and subsequently pressed into the recess.

12. A bag produced by using the method according to claim 9, characterized in that the edge has been folded about a fold line, with the seam being located near said fold line.

13. A bag according to claim 12, characterized in that the folded edge abuts against a wall of the bag, wherein, after the walls of the bag located on either side of the seam have been moved apart and the seam has been broken, the edge tends to move towards the position in which it abuts against the wall.

14. A bag according to claim 13, characterized in that the edge can be held in the position in which it abuts against the wall by means of a resealable adhesive strip.
